(19) United States
(12) Patent Application Publication
(10) Pub. No.: US 2025/0375771 A1
(43) Pub. Date: Dec. 11, 2025

(54) System Arrangement and Method for Grinding Starting Materials

(71) Applicant: NETZSCH Trockenmahltechnik GmbH, Hanau (DE)

(72) Inventors: Robert Rosen, Bobingen (DE); Gerhard Kolb, Rehau (DE); Christof Barth, Selb (DE); Xavier Costa, Sant Cugat del Vallès (ES); Evaldo Martin, Llica de Vall (ES)

(21) Appl. No.: 19/218,783

(22) Filed: May 27, 2025

(30) Foreign Application Priority Data
Jun. 6, 2024 (DE) 10 2024 115 762.3

(51) Int. Cl. B02C 17/16; B02C 23/16

(52) U.S. Cl. CPC B02C 17/16; B02C 23/16; B02C 2023/165

(57) ABSTRACT

A system arrangement for grinding starting materials. Such a system arrangement thereby includes an agitator bead mill with filling system for starting materials to be ground and a classifier wheel, which is coupled to the agitator bead mill. The filling system as well as the classifier wheel are thereby arranged essentially horizontally with respect to a longitudinal extension of the agitator bead mill. In addition, a method for grinding starting materials is shown.

### TECHNICAL FIELD

The present invention relates to a system arrangement for grinding starting materials as well as to a corresponding method.

### BACKGROUND

The comminuting or grinding, respectively, of starting materials, in order to subsequently use the starting materials prepared by doing this for the production of products, requires the use of machines.

In addition to the time, which must be scheduled for the grinding process, further work resources, such as, for instance, specialized personnel and work surfaces, are also necessary, in addition to energy, in order to achieve qualitatively sophisticated results.

One example from the manufacturing industry of film lies in the grinding of fillers, which are subsequently used, for instance, for the production of water vapor-permeable films. Water vapor-permeable films are required, for examples, for diapers and other liquid-absorbing products in the field of personal hygiene or also in the construction industry.

Water vapor-permeable films can, for instance, be provided as breathable plastic films, wherein a use besides in diapers is also conceivable in sanitary napkin products or, for instance, in packaging films.

Common fillers for the above-described areas of application are generally based on forms of calcium carbonate with a particle size distribution of 4-6%<0.4 μm, 50% to 80%<2 μm and 98%<4 μm.

Such a filler is added, for instance, into a master batch of the plastic (PE/PP films), in order to then ultimately create the film. The aims is thereby a steep particle size distribution with a low percentage in the submicron range of below 0.4 μm. The low percentage in the submicron range reduces the viscosity in the extruder and minimizes the need for coating agents. In addition, the filler with the particle size distribution of 4-6%<0.4 μm, 50% to 80%<2 μm and 98%<4 μm improves the permeability of the plastic film. The film thus becomes permeable for a gas, such as, air, for example.

To improve and homogenize the filler in response to the extruding for the production of the master batch, the filler or the completely ground filler powder, respectively, is generally treated with stearic acid. This process is referred to as coating.

Methods, which initially provide for the creation of a preliminary product, which is produced, for instance, on vertical roller mills, pendular roller mills or also on impact mills, are already known from the prior art.

Such a preliminary product can thereby have a particle size distribution of <75 μm with few ultra-fine particles of <2 μm. This preliminary product is subsequently fed onto wet-operated agitator bead mills, wherein a vertical filling is provided.

A concentration is thereby set to a maximum value of 30-35 m-%. The agitator bead mill is operated, for example, so that the above-described particle size distribution is maintained.

For the further use, this product has to be dewatered, dried, coated and then deagglomerated. In most cases, this is also followed by a further step by means of screening, in order to separate hard agglomerates, which may have been created. This material has to then be coated in a further step.

This process is complex and requires a very large amount of energy in various forms. Depending on the used calcium carbonate type (argonite, limestone, marble, calcite or the like), the specific process energy from pre-grinding, grinding and drying lies in a range of up to 1,000 kWh/t.

### SUMMARY

In light of the foregoing, the present invention is based on the object of producing a system arrangement, by means of which an energy-efficient grinding process is possible.

This object is solved by means of a system arrangement with the features of patent claim as well as by means of a method with the features of patent claim

A system arrangement for grinding starting materials is provided accordingly. Such a system arrangement comprises an agitator bead mill with filling system for starting materials to be ground and a classifier wheel, which is coupled to the agitator bead mill.

The filling system as well as the classifier wheel are thereby arranged essentially horizontally with respect to a longitudinal alignment of the agitator bead mill. An essentially horizontal alignment allows certain degrees of freedom, so that a slightly offset position to the longitudinal direction is to be considered to be acceptable for a production process, which can be attained in a stable manner. For instance, a deviation with an angle of up to 20° with respect to a longitudinal direction can be considered to be acceptable.

A deviation with an angle of up to 20°, for example in an interval of 5° to 20°, preferably of 10° to 20°, preferably of 15° to 20°, has the advantage that a particularly flexible system arrangement can thus be provided because such an arrangement can be reliably combined with a plurality of possible additional components. This is advantageous in particular for the maintenance and can sometimes have a positive effect on a more favorable cost-benefit balance in this area during the use phase.

A corresponding method for grinding starting materials is furthermore provided. Such a method thereby comprises the following steps: providing and operating an agitator bead mill with filling system; providing and operating a classifier wheel coupled to the agitator bead mill, wherein the filling system as well as the classifier wheel are essentially arranged and operated horizontally with respect to a longitudinal alignment of the agitator bead mill.

An idea, on which the invention is based, is to ensure a steady and continuous supply of fresh starting materials as well as of starting materials, which have not been ground in the desired shape yet, to the presented system arrangement, in order to thus promote a particularly energy-efficient grinding process.

It is provided thereby that the steady supply can be attained by means of an essentially horizontal arrangement of components, such as filling system and classifier wheel, because a re-squeezing of large volumes of the starting material, as it is known in the case of vertically arranged systems, can be avoided. The starting materials to be ground can thus be fed with an average particle size of 4 mm directly into the system arrangement, so that a pre-grinding and in particular the energy input associated therewith can be dispensed with.

According to one exemplary embodiment of the system arrangement, the agitator bead mill has grinding bodies, which have a size of between 1 and 10 mm, preferably between 2 and 9 mm, preferably between 3 and 8 mm, preferably between 4 and 6 mm.

Depending on the desired state of the fed starting materials, a desired grinding result can thus be attained with little energy input.

According to a further development of the system arrangement, the coupling between agitator bead mill and classifier wheel is designed to provide a closed grinding and classifying circulation system.

The grinding material, in other words the starting material, can be transported into a classifier wheel at the discharge of the agitator bead mill. The separation of the filler takes place in the coupled classifier wheel. The coarse material can subsequently reach the mill directly, for example proportionately under the effect of gravity, and can thus be ground down completely in a closed grinding and classifying circulation system. A closed grinding and classifying circulation system is advantageous because additional energy-intensive intermediate steps in terms of a complex reloading or further filling steps of the system arrangement with grinding material have to thus not be provided.

According to a further development of the system arrangement, the coupling between agitator bead mill and classifier wheel is additionally designed to provide a pneumatically operable grinding and classifying circulation system.

The above-mentioned advantages can thus be attained even better.

According to one exemplary embodiment of the system arrangement, the agitator bead mill is designed to be operable exclusively in a dry operating state.

For this dry process, which is possible with this, the specific energy to be expended is <200 kWh/t and thus lies several times below the current wet process. The reason for this is that a subsequent dewatering and drying can thus be dispensed with.

According to a further development of the system arrangement, the system arrangement comprises means and is designed to continuously accept a fill volume of starting material to be ground as a function of a removal volume of completely ground starting material.

In other words, the material volume adequately corresponding to the end product is continuously added to the mill in the form of fresh material, in other words starting material, which is to be ground. A mill, which is thus continuously loaded in an optimal manner, can thus be operated in a particularly energy-efficient manner because the used energy is used in the best possible way.

According to another further development of the presented invention, the system arrangement is designed to produce completely ground starting material at least proportionately with a particle size distribution of 4-6%<0.6 μm, preferably of <0.4 μm, 50%-80%<3 μm, preferably of 2 μm, and 98%<5 μm, preferably of 4 μm.

An end product, which is finely ground in this way, is particularly advantageously suitable to be used, for instance, for the production of breathable plastic films. Slight deviations are then tolerable as long as a steep particle size distribution with a low percentage in the submicron range of below 0.4 μm can be produced.

The presented combination and alignment of the respective components of the system arrangement according to the invention promotes in a particularly advantageous manner that this result can be effected in a reliable and energy-efficient manner. In particular the supply of starting material to be ground, which is limited due to the essentially horizontal alignment, into the actual grinding process ensures a steady and energy-efficient processing.

According to one exemplary embodiment of the method according to the invention, the agitator bead mill is provided and operated with grinding bodies, which have a size of between 1 and 10 mm, preferably between 2 and 9 mm, preferably between 3 and 8 mm, preferably between 4 and 6 mm.

Depending on the desired state of the fed starting materials, a desired grinding result can thus be achieved with little energy input.

According to a further development of the presented method, the agitator bead mill and the classifier wheel are operated by maintaining a closed, pneumatic grinding and classifying circulation system, so that starting material, which has not been completely ground yet, is guided in the circuit until the final grinding.

The grinding material, in other words the starting material, can be transported into a classifier wheel at the discharge of the agitator bead mill. The separation of the filler takes place in the coupled classifier wheel. The coarse material can subsequently reach the mill directly, for example proportionately under the effect of gravity, and can thus be ground down completely in a closed grinding and classifying circulation system. A closed grinding and classifying circulation system is advantageous because additional energy-intensive intermediate steps in terms of a complex reloading or further filling steps of the system arrangement with grinding material have to thus not be provided.

According to one exemplary embodiment of the method, the agitator bead mill is operated exclusively in a dry operating state.

For this dry process, which is possible with this, the specific energy to be expended is <200 kWh/t and thus lies several times below the current wet process. The reason for this is that a subsequent dewatering and drying can thus be dispensed with. In contrast to the prior art, which relies on an exclusively wet process, in other words a wet grinding, the subsequent drying of the grinding material can thus be dispensed with due to the presented dry grinding, so that a particularly energy-efficient process can be carried out. A dry operating state in the case of an agitator bead mill is in particular defined in that no liquids whatsoever for promoting the grinding are added during the grinding of mineral starting materials.

According to a further exemplary embodiment of the method, a completely ground starting material at least proportionately with a particle size distribution of 4-6%<0.6 μm, preferably of <0.4 μm, 50%-80%<3 μm, preferably of 2 μm, and 98%<5 μm, preferably of 4 μm, is produced by means of the presented method according to the invention.

A starting material finely ground in this way or ground end product, respectively, is particularly advantageously suitable to be used, for instance, for the production of breathable plastic films. Slight deviations are then tolerable as long as a steep particle size distribution with a low percentage in the submicron range of below 0.4 μm can be produced.

The combinations and alignments of the respective components of the system arrangement described in the method according to the invention promote in a particularly advantageous manner that this grinding result can be effected in a reliable and energy-efficient manner. In particular the supply of starting material to be ground, which is limited due to the essentially horizontal alignment, into the actual grinding process ensures a steady and energy-efficient processing.

### BRIEF DESCRIPTION OF THE DRAWINGS

The invention will be described in more detail with reference to exemplary embodiments, which are illustrated in the enclosed drawings.

The enclosed drawings are included, in order to provide a further understanding of this invention and are incorporated in this description and represent a part thereof. The drawings illustrate the embodiments of this invention and, together with the description, serve the purpose of explaining the principles of the invention.

Other embodiments of this invention and many of the provided advantages of this invention can be understood easily when they become better understandable by making reference to the following detailed description.

The elements of the drawings are not necessarily drawn at the same scale to one another. Identical reference numerals therefore identify similar parts.

FIG. 1 shows a schematic illustration of a system arrangement for grinding starting materials according to an exemplary embodiment of the present invention;

FIG. 2 shows a schematic flowchart for a method for grinding starting materials according to an exemplary embodiment of the present invention.

In the figures, identical reference numerals refer to identical or functionally similar components, unless otherwise specified. All directional designations, such as “top”, “bottom”, “left”, “right”, “above”, “below”, “horizontal”, “vertical”, “rear”, “front” and similar terms are used only for explanatory purposes and are not to limit the embodiments to the specific arrangements, which are illustrated in the drawings.

### DETAILED DESCRIPTION

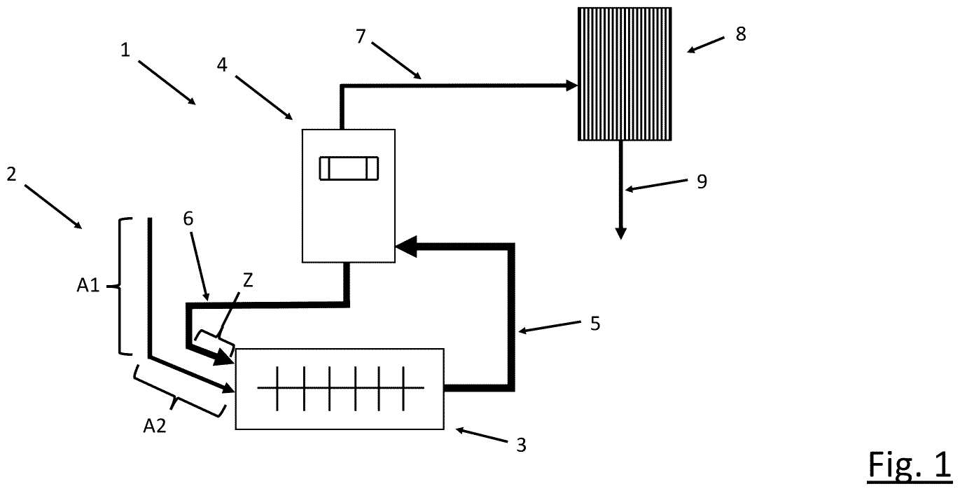

FIG. 1 shows a schematic illustration of a system arrangement 1 for grinding starting materials, which are not shown in more detail, according to an exemplary embodiment of the present invention.

The starting materials to be ground, which can also be referred to as feed material, are introduced via a schematically illustrated filling system 2 into an agitator bead mill 3, which is likewise schematically illustrated. The shown agitator bead mill 3 is an agitator bead mill 3, which can be operated in a dry manner and which is aligned horizontally, based on its longitudinal direction.

The agitator bead mill 3 is operated in a dry manner, wherein a grinding body, which is not illustrated in more detail, can have a size of, for example, between 1 and 10 mm, preferably between 2 and 9 mm, preferably between 3 and 8 mm, preferably between 4 and 6 mm, in the agitator bead mill 3.

The filling system 2 is illustrated in FIG. 1 with a first section A1 and a second section A2. In addition, the filling system 2 is illustrated so as to be arranged essentially horizontally, with respect to a longitudinal alignment of the agitator bead mill 3. In particular, the second section A2 is thereby illustrated so as to be aligned essentially horizontally. In this respect, the starting materials to be ground, which are not illustrated in more detail, are introduced essentially horizontally into the agitator bead mill 3 via the filling system 2.

An essentially horizontal alignment allows for certain degrees of freedom, so that a slightly offset position to the longitudinal direction is to be considered to be acceptable for a production process, which can be attained in a stable manner. For instance, a deviation with an angle of up to 20° with respect to a longitudinal direction can thus be considered to be acceptable. A deviation with an angle of up to 20°, for example in an interval of 5° to 20°, preferably of 10° to 20°, preferably of 15° to 20°, has the advantage that a particularly flexible system arrangement can be provided because such an arrangement can be reliably combined with a plurality of possible additional components. This is advantageous in particular for the maintenance and can sometimes have a positive effect on a more favorable cost-benefit balance in this area during the use phase.

The system arrangement 1 is further provided with a classifier wheel 4, which is illustrated so as to be coupled to the agitator bead mill 3 via a first supply line 5. Grinding material reaches from the agitator bead mill 3 via this first supply line 5 to the classifier wheel 4.

In this schematically illustrated two-dimensional drawing, the classifier wheel 4 is provided essentially in a same plane behind the agitator bead mill 3. In this respect, the classifier wheel 4 is provided so as to be arranged essentially horizontally with respect to a longitudinal extension of the agitator bead mill 3.

In exemplary embodiments, which are not illustrated in more detail, it is conceivable that the classifier wheel 4 is provided so as to be arranged, for example, essentially to the left of the agitator bead mill 3, based on the image plane.

Other arrangements, which essentially provide an alignment of the classifier wheel 4 in one plane with the agitator bead mill 3, are possible, as long as a return of substances to be ground from the classifier wheel 4 to the agitator bead mill 3 can be carried out essentially horizontally with respect to a longitudinal alignment of the agitator bead mill 3 via the filling regions of the agitator bead mill 3, which are provided for this purpose.

A second supply line 6 leads from the classifier wheel 4 back to the agitator bead mill 3. The separation of completely ground starting material, which is now supplied to a filter system 8 as completely produced filler via a third supply line 7, takes place in the classifier wheel 4. The filter system 8 is not part of the system arrangement 1 and is only optionally provided here. Via a fourth supply line 9, the completely ground starting material leaves the production process in filtered form as completely produced filler, which can now also be referred to as fine material.

Starting material, which has not been completely ground, which can also be referred to as coarse material, is guided back to the dry, horizontal agitator bead mill 3 via the second supply line 6 and is ground again.

In this respect, the coupling between agitator bead mill 3 and classifier wheel 4, which is produced by means of the first supply line 5 and the second supply line 6, is designed to provide a closed grinding and classifying circulation system.

In particular a supply section Z of the second supply line 6 is thereby illustrated so as to be arranged essentially horizontally with respect to a longitudinal alignment of the agitator bead mill 3.

In this respect, the supply section Z of the second supply line 6 is illustrated parallel to the second section A2 of the filling system 2, wherein both are provided so as to be aligned essentially horizontally with respect to a longitudinal alignment of the agitator bead mill 3.

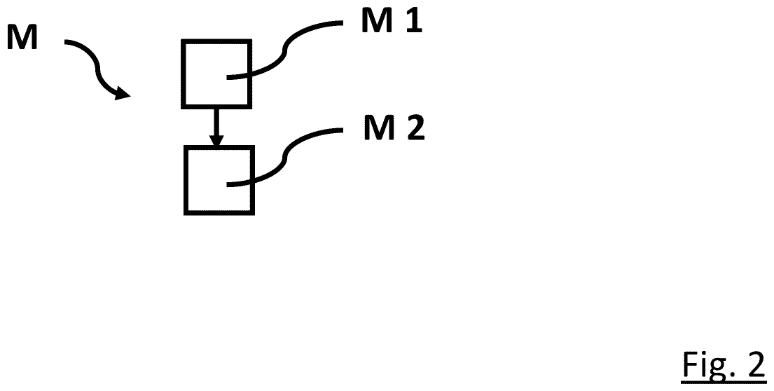

FIG. 2 shows a schematic flowchart for a method M for grinding starting materials according to an exemplary embodiment of the present invention. In a first method step M1, an agitator bead mill 3 with filling system 2 is provided and operated. In a second method step M2, a classifier wheel 4 coupled to the agitator bead mill 3 is provided and operated, wherein the filling system 2 as well as the classifier wheel 4 are arranged and operated essentially horizontally with respect to a longitudinal alignment of the agitator bead mill 3.

1. A system arrangement for grinding starting materials comprising an agitator bead mill with filling system for starting materials to be ground and a classifier wheel, which is coupled to the agitator bead mill, wherein the filling system as well as the classifier wheel are arranged essentially horizontally with respect to a longitudinal extension of the agitator bead mill.

2. The system arrangement according to claim 1, wherein grinding bodies in the agitator bead mill have a size of between 1 and 10 mm, preferably between 2 and 9 mm, preferably between 3 and 8 mm, preferably between 4 and 6 mm.

3. The system arrangement according to claim 1, wherein the coupling between agitator bead mill and classifier wheel is designed to provide a closed grinding and classifying circulation system.

4. The system arrangement according to claim 3, wherein the coupling between agitator bead mill and classifier wheel is additionally designed to provide a pneumatically operable grinding and classifying circulation system.

5. The system arrangement according to claim 1, wherein the agitator bead mill is designed to be operable exclusively in a dry operating state.

6. The system arrangement according to claim 1, wherein the system arrangement comprises means and is designed to continuously accept a fill volume of starting material to be ground as a function of a removal volume of completely ground starting material.

7. The system arrangement according to claim 1, wherein the system arrangement is designed to produce completely ground starting material at least proportionately with a particle size distribution of 4-6%<0.6 μm, preferably of <0.4 μm, 50%-80%<3 μm, preferably of 2 μm, and 98%<5 μm, preferably of 4 μm.

8. A method for grinding starting materials comprising the following steps:
providing and operating an agitator bead mill with filling system; providing and operating a classifier wheel coupled to the agitator bead mill,
wherein the filling system as well as the classifier wheel are arranged and operated essentially horizontally with respect to a longitudinal alignment of the agitator bead mill.

9. The method according to claim 8, wherein the agitator bead mill is provided and operated with grinding bodies, which have a size of between 1 and 10 mm, preferably between 2 and 9 mm, preferably between 3 and 8 mm, preferably between 4 and 6 mm.

10. The method according to claim 8, wherein the agitator bead mill and the classifier wheel are operated by maintaining a closed, pneumatic grinding and classifying circulation system, so that starting material, which has not been completely ground yet, is guided in the circuit until the final grinding.

11. The method according to claim 8, wherein the agitator bead mill is operated exclusively in a dry operating state.

12. The method according to claim 8, wherein completely ground starting material at least proportionately with a particle size distribution of 4-6%<0.6 μm, preferably of <0.4 μm, 50%-80%<3 μm, preferably of 2 μm, and 98%<5 μm, preferably of 4 μm, is produced by means of the method.

13. The system arrangement according to claim 2, wherein the coupling between agitator bead mill and classifier wheel is designed to provide a closed grinding and classifying circulation system.

14. The system arrangement according to claim 2, wherein the agitator bead mill is designed to be operable exclusively in a dry operating state.

15. The system arrangement according to claim 2, wherein the system arrangement comprises means and is designed to continuously accept a fill volume of starting material to be ground as a function of a removal volume of completely ground starting material.

16. The system arrangement according to claim 2, wherein the system arrangement is designed to produce completely ground starting material at least proportionately with a particle size distribution of 4-6%<0.6 μm, preferably of <0.4 μm, 50%-80%<3 μm, preferably of 2 μm, and 98%<5 μm, preferably of 4 μm.

17. The method according to claim 9, wherein the agitator bead mill is operated exclusively in a dry operating state.

18. The method according to claim 9, wherein completely ground starting material at least proportionately with a particle size distribution of 4-6%<0.6 μm, preferably of <0.4 μm, 50%-80%<3 μm, preferably of 2 μm, and 98%<5 μm, preferably of 4 μm, is produced by means of the method.
